(19) United States
(12) Patent Application Publication
(10) Pub. No.: US 2025/0309558 A1
(43) Pub. Date: Oct. 2, 2025

(54) ANTENNA DEVICE

(71) Applicant: Mitsubishi Electric Corporation, Tokyo (JP)

(72) Inventors: Shimpei AKIMOTO, Tokyo (JP); Kengo NISHIMOTO, Tokyo (JP)

(73) Assignee: Mitsubishi Electric Corporation, Tokyo (JP)

(21) Appl. No.: 19/240,193

(22) Filed: Jun. 17, 2025

Related U.S. Application Data
(63) Continuation of application No. PCT/JP2023/007931, filed on Mar. 3, 2023.

(51) Int. Cl. H01Q 19/00; H01Q 1/12; H01Q 9/26; H01Q 9/30

(52) U.S. Cl. CPC H01Q 19/005; H01Q 1/1271; H01Q 9/26; H01Q 9/30

(57) ABSTRACT

An antenna device includes: a transparent antenna conductor including a notch; a glass provided with the antenna conductor; a metal sash provided adjacent to the antenna conductor; and an opaque antenna conductor provided to the metal sash without contacting the antenna conductor, and disposed adjacent to the notch without protruding from the metal sash toward the glass.

### CROSS REFERENCE TO RELATED APPLICATIONS

This application is a Continuation of PCT International Application No. PCT/JP2023/007931 filed on Mar. 3, 2023, all of which is hereby expressly incorporated by reference into the present application.

### TECHNICAL FIELD

The present disclosure relates to an antenna device.

### BACKGROUND ART

There has been known an antenna device that includes a power feeding conductor that emits a radio wave by power feeding, and a parasitic conductor for enhancing antenna performance of this power feeding conductor. In the antenna device, the parasitic conductor is disposed at a position at which the parasitic conductor does not contact the power feeding conductor. A radio wave is emitted from the power feeding conductor supplied with a driving current, and through spatial coupling between the power feeding conductor and the parasitic conductor, an induced current corresponding to the driving current flows in the parasitic conductor. The parasitic conductor is excited by this induced current, thereby enhancing the antenna performance.

Furthermore, there has been known a transparent conductive material that is optically transparent, yet has conductivity. By using this transparent conductive material for the above parasitic conductor, it is possible to implement an antenna device that is invisible or unnoticeable. For example, Patent Literature 1 discloses an antenna that includes a power feeding antenna element that is a power feeding conductor, and a transparent parasitic antenna element for which a transparent conductive film has been used.

### CITATION LIST

### Patent Literature

Patent Literature 1: JP 2021-72461 A

### SUMMARY OF INVENTION

### Technical Problem

A conventional antenna device including a transparent parasitic conductor and an opaque power feeding conductor is provided to a structure such as a window frame. In a case where, for example, a design that makes a parasitic conductor invisible or unnoticeable is adopted, the transparent parasitic conductor is provided to a transparent member such as a glass, and a metal member such as a metal sash that supports the transparent member is provided with an opaque power feeding conductor.

However, to enhance spatial coupling between a parasitic conductor and a power feeding conductor to excite the parasitic conductor, it has been necessary for a conventional antenna device to dispose an opaque power feeding conductor in such a way that the power feeding conductor protrudes toward a side of a transparent member provided with the parasitic conductor. Therefore, there has been a problem that part of the opaque power feeding conductor is visually recognized through the transparent member, and design quality is lowered.

Furthermore, with a power feeding conductor disposed in such a way that the power feeding conductor does not protrude toward a transparent member side, the strength of spatial coupling between the parasitic conductor and the power feeding conductor is reduced.

Note that, in the conventional antenna device described in Patent Literature 1, the power feeding conductor and the parasitic conductor are disposed spatially overlapping each other without contacting each other. Hence, even if a configuration of the antenna device is applied to a structure such as a window frame, part of the opaque power feeding conductor is visually recognized through the parasitic conductor.

Furthermore, if the feed conductor and the parasitic conductor are arranged so as not to overlap spatially, there is a concern that the strength of the spatial coupling between them may be reduced.

The present disclosure solves the above problem, and an object of the present disclosure is to provide an antenna device that can excite a transparent parasitic conductor without exposing an opaque power feeding conductor through a transparent member provided with the parasitic conductor.

### Solution to Problem

An antenna device according to the present disclosure includes: a transparent parasitic conductor including a notch; a transparent member provided with the parasitic conductor; a metal member provided adjacent to the parasitic conductor; and an opaque power feeding conductor provided to the metal member without contacting the parasitic conductor, and disposed adjacent to the notch without protruding from the metal member toward the transparent member.

### Advantageous Effects of Invention

According to the present disclosure, the opaque power feeding conductor is provided to the metal member without contacting the transparent parasitic conductor including the notch, and disposed adjacent to the notch without protruding from the metal member toward the transparent member. When a magnetic field generated in the power feeding conductor by power feeding enters the notch, the antenna device according to the present disclosure can excite the transparent parasitic conductor without exposing the opaque power feeding conductor through the transparent member provided with the transparent parasitic conductor.

### BRIEF DESCRIPTION OF DRAWINGS

FIG. 1 is a perspective view illustrating a schematic configuration of an antenna device according to Embodiment 1.

FIG. 2 is a view illustrating antenna characteristics of the antenna device obtained by removing a parasitic conductor from the antenna device in FIG. 1.

FIG. 3 is a view illustrating radiation characteristics of the antenna device in FIG. 1.

FIG. 4 is a perspective view illustrating a schematic configuration of a conventional antenna device.

FIG. 5 is a view illustrating radiation characteristics of the antenna device in

FIG. 4.

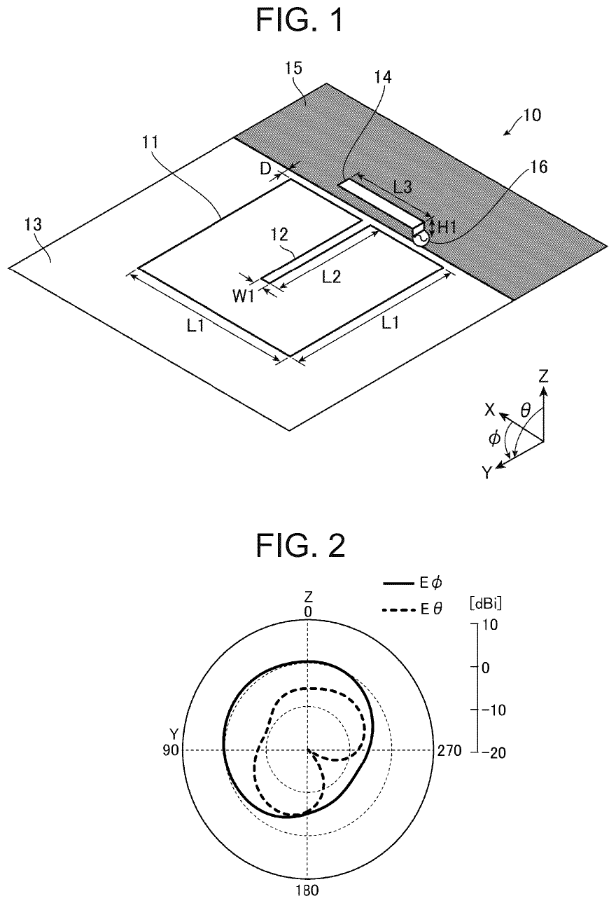

FIG. 6 is a perspective view illustrating a schematic configuration of the antenna device obtained by removing a notch from the antenna device in FIG. 1.

FIG. 7 is a view illustrating antenna characteristics of the antenna device obtained by removing the notch from the antenna device in FIG. 1.

FIG. 8 is a perspective view illustrating a schematic configuration of an antenna device according to Embodiment 2.

FIG. 9 is a view illustrating radiation characteristics of the antenna device obtained by removing a parasitic conductor from the antenna device in FIG. 8.

FIG. 10 is a view illustrating radiation characteristics of the antenna device in FIG. 8.

FIG. 11 is a perspective view illustrating a schematic configuration of an antenna device according to Embodiment 3.

FIG. 12 is a view illustrating radiation characteristics of the antenna device in FIG. 11.

FIG. 13 is a graph showing a relationship between radiation efficiency of the antenna device and a normalized frequency.

FIG. 14 is a perspective view illustrating a schematic configuration of an antenna device according to Embodiment 4.

FIG. 15 is an arrow view illustrating a schematic configuration of the antenna device seen from a direction of an arrow C in FIG. 14.

FIG. 16 is a perspective view illustrating a schematic configuration of an antenna device according to Embodiment 5.

FIG. 17 is a view illustrating impedance characteristics of the antenna device in FIG. 16.

FIG. 18 is a view illustrating radiation characteristics of the antenna device in FIG. 16.

### DESCRIPTION OF EMBODIMENTS

### Embodiment 1

FIG. 1 is a perspective view illustrating a schematic configuration of an antenna device 10 according to Embodiment 1. In FIG. 1, the antenna device 10 is an antenna device whose wavelength of a center frequency f₀ of a frequency band for intended use is λ, and includes an antenna conductor 11, a notch 12, a glass 13, an antenna conductor 14, a metal sash 15, and a power feeding point 16.

The antenna conductor 11 is a transparent parasitic conductor. For example, the antenna conductor 11 is a transparent conductive film of a rectangular shape. In FIG. 1, the antenna conductor 11 is a conductor of a square shape whose length of one side is L1. Note that the antenna conductor 11 is not limited to the square shape, and may have an oblong shape or may have a circular shape instead of the rectangular shape. The transparent conductive film is a conductive film formed using a transparent conductive material.

The notch 12 is a notch provided to the antenna conductor 11. For example, the notch 12 is a linear slit whose end part on the metal sash 15 side (−Y direction) is opened, and that extends in a direction (+Y direction) apart from the metal sash 15. In FIG. 1, the notch 12 has a length L2 and a width W1. Note that the notch 12 is not limited to the linear slit, and may be a meandering slit.

The glass 13 is a transparent member provided with the antenna conductor 11. For example, the glass 13 is a glass of a flat shape, and has the surface on which the antenna conductor 11 is disposed. The glass 13 has the flat shape in FIG. 1, yet may have a shape having a curved surface in a protrusion direction or a recess direction.

Since the antenna conductor 11 is transparent, the glass 13 provided with the antenna conductor 11 has an external appearance that is invisible or unnoticeable.

The antenna conductor 14 is an opaque parasitic conductor formed using a metal material such as a sheet metal. The antenna conductor 14 is provided to the metal sash 15 without contacting the antenna conductor 11, and is disposed adjacent to the notch 12 without protruding from the metal sash 15 toward the glass 13. For example, as illustrated in FIG. 1, the antenna conductor 14 has an L shape, and the length of a longer plate-like part of the L shape is L3 and the length of a shorter plate-like part of the L shape is H1.

The antenna conductor 14 is a monopole conductor whose end part of the shorter plate-like part of the L shape is connected to the power feeding point 16 on the metal sash 15, and for which the metal sash 15 is used as a ground potential. The length H1 of the shorter plate-like part of the L shape is the height of the antenna conductor 14 from the power feeding point 16 on the metal sash 15.

On the metal sash 15, the plate-like part of the antenna conductor 14 having the length L3 is disposed along an X axis direction, and the shorter plate-like part is disposed on the metal sash 15 with the power feeding point 16 interposed therebetween. Furthermore, as illustrated in FIG. 1, the plate-like part of the antenna conductor 14 having the length L3 is disposed adjacent to an open end of the notch 12, and when viewed from above, a virtual line along a direction in which the notch 12 linearly extends is perpendicular to a virtual line along a longitudinal direction (+X direction) of the above plate-like part.

Note that the antenna conductor 14 is not limited to the L shape, and may have an F shape.

Furthermore, the antenna conductor 14 may be a substrate pattern. For example, the antenna conductor 14 is a substrate pattern formed as a copper foil pattern on a dielectric substrate, and the dielectric substrate is provided on the metal sash 15. In a case where the dielectric substrate is a multilayer substrate, the substrate pattern for forming the antenna conductor 14 may be provided not only on a surface layer, but also on an inner layer of the substrate. Note that the substrate pattern also includes vias that electrically connect copper foil patterns between substrate layers.

The metal sash 15 is a metal member provided adjacent to the antenna conductor 11. For example, the metal sash 15 is a metal window frame that supports the glass 13 in a glass window provided with the antenna device 10. In FIG. 1, a distance from the metal sash 15 to the antenna conductor 11 is D.

Note that, although the case has been described where the metal member on which the antenna conductor 14 is disposed is the metal sash 15, the metal member may be a member having a shape, size, or structure suitable for the application of the antenna device 10.

The power feeding point 16 is a part that feeds electrical power to the antenna conductor 14, and is provided between the end part of the antenna conductor 14 and the metal sash 15. In a case where, for example, the antenna conductor 14 has the L shape, the power feeding point 16 connected with the end part of the shorter plate-like part of the L shape is provided on the metal sash 15 without conducting with the metal sash 15.

When a driving current is supplied from the power feeding point 16 to the antenna conductor 14, the antenna conductor 14 excites, and a radio wave is emitted in a direction (−Z direction) vertical to the surface of the glass 13. At this time, through spatial coupling between the antenna conductor 11 and the antenna conductor 14, an induced current corresponding to the driving current flowing in the antenna conductor 14 is generated in the antenna conductor 11. The antenna conductor 11 is excited by the induced current, and radio wave radiation characteristics in the −Z direction of the antenna conductor 14 are improved.

In the antenna device 10, the length L1 of the antenna conductor 11 is, for example, 0.5λ. The length L2 of the notch 12 is, for example, 0.3λ, and the width W1 is, for example, 0.02λ. The length L3 of the antenna conductor 14 is, for example, 0.2λ, and the height H1 is, for example, 0.02λ. Furthermore, the distance D between the antenna conductor 11 and the metal sash 15 is, for example, 0.02λ.

FIG. 2 is a view illustrating antenna characteristics of the antenna device obtained by removing the antenna conductor 11 from the antenna device 10, and illustrates a result obtained by simulating the radiation characteristics of the antenna device from which the antenna conductor 11 has been removed. The radiation characteristics are a radio wave radiation pattern of the antenna device on a ZY plane in FIG. 1. Since the antenna conductor 14 does not protrude from the metal sash 15 toward the glass 13 side and extends in parallel to a boundary between the glass 13 and the metal sash 15, that is, in the X axis direction, a main polarized wave is a linearly-polarized wave Eφ indicated by a solid line in FIG. 2 along the X axis direction. Furthermore, Eθ indicated by a broken line is a cross-polarized wave.

As is clear from FIG. 2, in the antenna device from which the antenna conductor 11 has been removed, a directional gain in the −Z direction (θ=) 180° in which the antenna conductor 14 is hidden by the metal sash 15 is lower than that in a +Z direction (θ=0°) and is approximately −5 dBi.

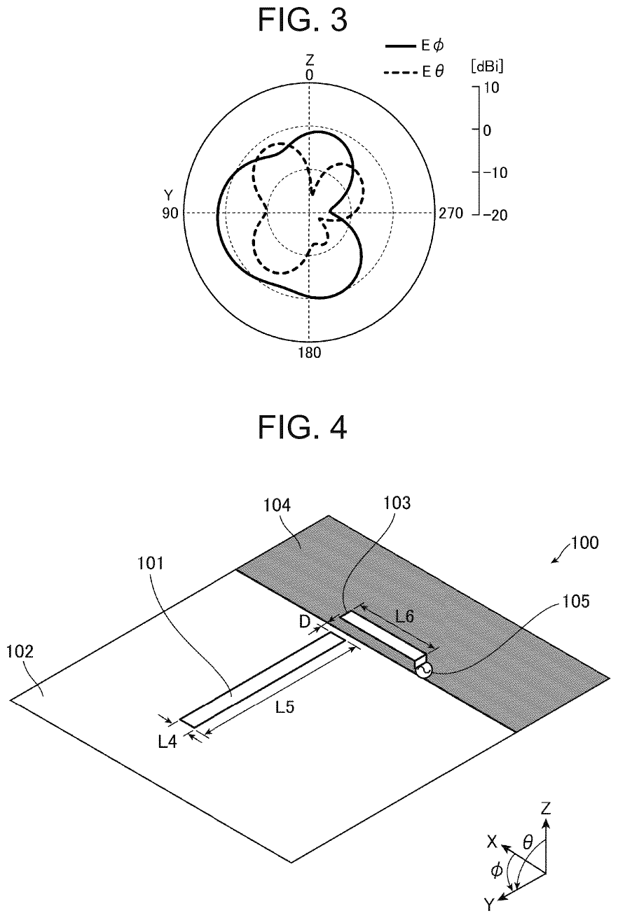

FIG. 3 is a view illustrating radiation characteristics of the antenna device 10, and illustrates a result obtained by simulating the radiation characteristics of the antenna device 10. The radiation characteristics are a radio wave radiation pattern of the antenna device 10 on the ZY plane in FIG. 1. Ep indicated by a solid line in FIG. 3 is a linearly-polarized wave along the X axis direction, and Eθ indicated by a broken line is a cross-polarized wave.

Since, in the antenna device 10, the antenna conductor 14 is provided to the metal sash 15 without protruding toward the glass 13, and the longer plate-like part of the L shape of the antenna conductor 14 extends in the X axis direction, the linearly-polarized wave Eφ along the X axis direction is a main polarized wave.

As is clear from FIG. 3, the directional gain in the −Z direction of the antenna device 10 is improved by approximately 5 dB compared to the directional gain in the −Z direction of the antenna device illustrated in FIG. 2.

It is considered that the directional gain in the −Z direction illustrated in FIG. 3 is improved because, when electrical power is fed to the antenna conductor 14 in the antenna device 10, the magnetic field surrounding the antenna conductor 14 is generated, this magnetic field enters the notch 12, and thereby the antenna conductor 11 is excited without being influenced by the metal sash 15.

FIG. 4 is a perspective view illustrating a schematic configuration of a conventional antenna device 100, and illustrates an antenna device having a general structure including a parasitic conductor and a power feeding conductor. The antenna device 100 is an antenna device whose wavelength of the center frequency f₀ of a frequency band for intended use is λ, and includes an antenna conductor 101, a glass 102, an antenna conductor 103, a metal sash 104, and a power feeding point 105. In the antenna device 100, the glass 102, the metal sash 104, and the power feeding point 105 employ the same configurations as those of the glass 13, the metal sash 15, and the power feeding point 16 included in the antenna device 10 illustrated in FIG. 1.

The antenna conductor 101 is a transparent parasitic conductor similarly to the antenna conductor 11. In FIG. 4, the antenna conductor 101 is a transparent conductive film of a belt shape whose width is L4 and whose length is L5. In the glass 102, the antenna conductor 101 is provided in such a way that the longitudinal direction lies along a Y axis direction. The width L4 of the antenna conductor 101 is, for example, 0.04λ, and the length L5 is, for example, 0.5λ. Furthermore, a distance between the antenna conductor 101 and the metal sash 104 is D, the same as that of the antenna device 10.

The antenna conductor 103 is an opaque power feeding conductor formed using a metal material. Similarly to the antenna conductor 14, the antenna conductor 103 is provided to the metal sash 104 without contacting the antenna conductor 101, and is disposed without protruding from the metal sash 104 toward the glass 102 side. Furthermore, in FIG. 4, the antenna conductor 103 has an L shape, and the length of a longer plate-like part of the L shape is L6.

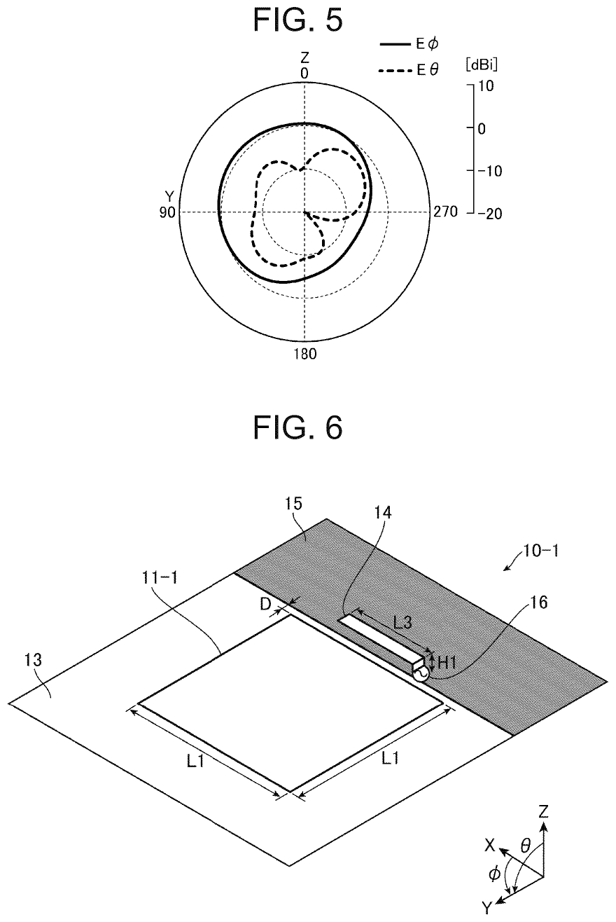

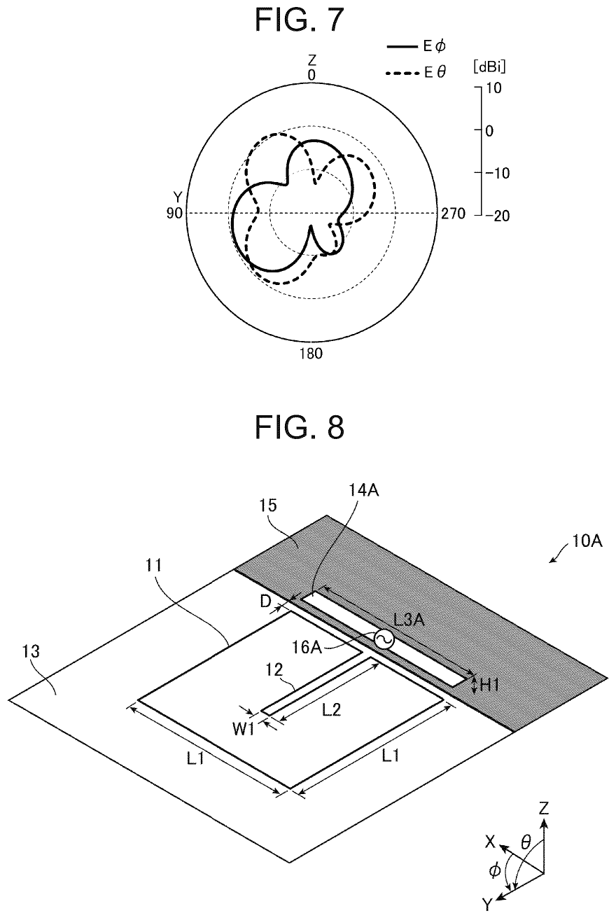

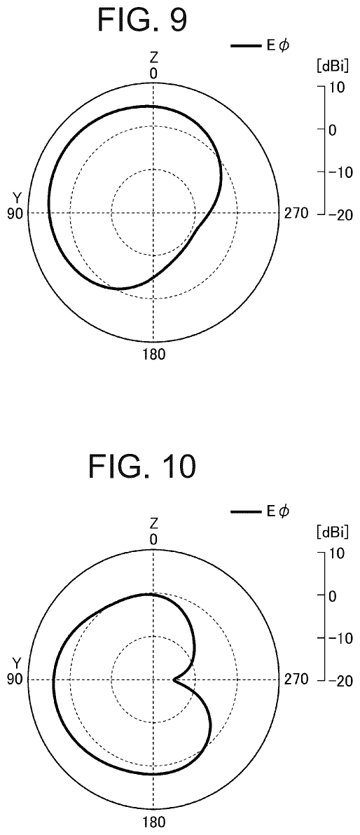

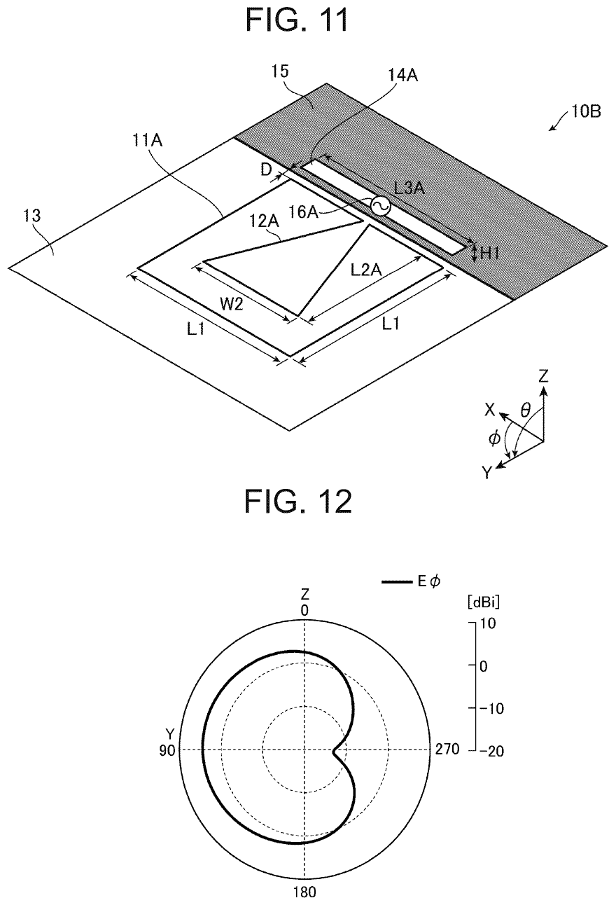

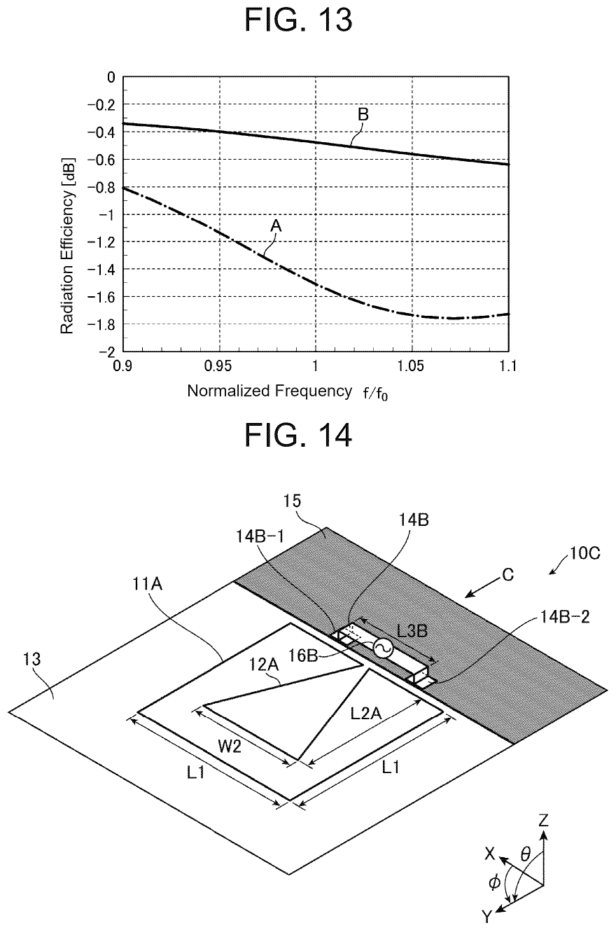

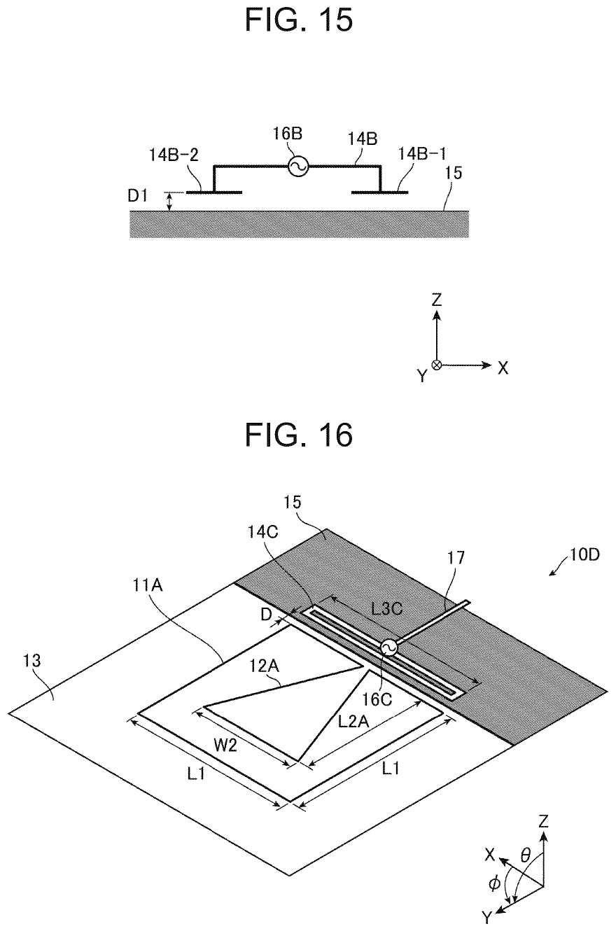

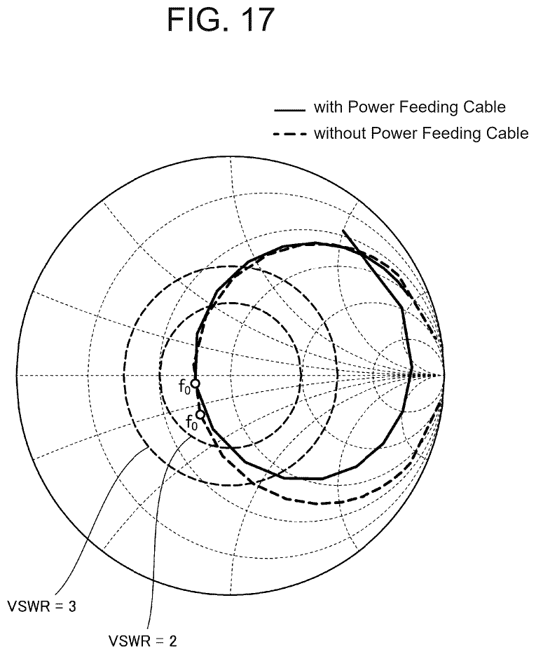

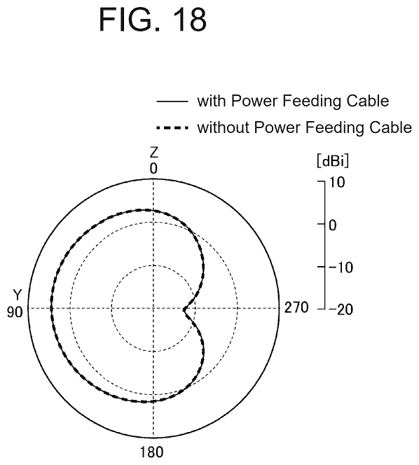

On the metal sash 104, a plate-like part of the antenna conductor 103 having the length L6 is disposed along the X axis direction, and a shorter plate-like part is disposed on the metal sash 104 with the power feeding point 105 interposed therebetween. Furthermore, as illustrated in FIG. 5, the antenna conductor 101 and the antenna conductor 103 are disposed in such a way that a distal end part of the longer plate-like part of the L shape of the antenna conductor 103, and an end part of the antenna conductor 101 on the antenna conductor 103 side are adjacent.

FIG. 5 is a view illustrating radiation characteristics of the antenna device 100, and illustrates a result obtained by simulating the radiation characteristics of the antenna device 100. The radiation characteristics are a radio wave radiation pattern of the antenna device 100 on the ZY plane in FIG. 4. Eφ indicated by a solid line in FIG. 5 is a linearly-polarized wave along the X axis direction, and Eθ indicated by a broken line is a cross-polarized wave.

Since, in the antenna device 100, the antenna conductor 103 is provided to the metal sash 104 without protruding toward the glass 102, and the longer plate-like part of the L shape of the antenna conductor 103 extends in the X axis direction, the linearly-polarized wave Eφ along the X axis direction is a main polarized wave. As is clear from FIG. 5, even though the antenna device 100 includes the antenna conductor 101, a directional gain in the −Z direction is not improved.

A reason why the directional gain in the −Z direction is not improved in the antenna device 100 is that, when electrical power is fed to the antenna conductor 103, a strong electrical field is generated between the antenna conductor 103 and the metal sash 104. That is, it is considered that the electrical field generated between the antenna conductor 103 and the metal sash 104 weakens an electrical field between an end part of the antenna conductor 103 (a distal end part of the longer plate-like part of the L shape) and an end part of the antenna conductor 101 (an end part on the antenna conductor 103 side), and therefore spatial coupling between the antenna conductor 101 and the antenna conductor 103 is reduced.

FIG. 6 is a perspective view illustrating a schematic configuration of an antenna device 10-1 obtained by removing the notch 12 from the antenna device 10. The antenna device 10-1 employs the same configuration as that of the antenna device 10, yet differs in including an antenna conductor 11-1 in which the notch 12 is not formed. Similarly to the antenna conductor 11, the antenna conductor 11-1 is a conductor of a square shape whose length of one side is L1. The antenna conductor 14 is provided to the metal sash 15 at an interval of the distance D spaced apart from the antenna conductor 11-1 so as not to contact the antenna conductor 11-1, and is disposed without protruding from the metal sash 15 toward the glass 13 side.

FIG. 7 is a view illustrating antenna characteristics of the antenna device 10-1, and illustrates a result obtained by simulating the radiation characteristics of the antenna device 10-1. The radiation characteristics are a radio wave radiation pattern of the antenna device 10-1 on the ZY plane in FIG. 7. Eφ indicated by a solid line in FIG. 7 is a linearly-polarized wave along the X axis direction, and Eθ indicated by a broken line is a cross-polarized wave. Since the longer plate-like part of the L shape of the antenna conductor 14 extends in the X axis direction, the linearly-polarized wave Eφ along the X axis direction is a main polarized wave.

In the antenna device 10-1, the notch 12 is not formed in the antenna conductor 11-1. Hence, even if the antenna device 10-1 includes the antenna conductor 11-1 that is a parasitic conductor, the directional gain in the −Z direction is not improved, and, to the contrary, lowered compared to the antenna device 100 that does not include the parasitic conductor. A reason for this is that the antenna conductor 11-1 that does not include the notch 12 acts as a 0.5λ-square scatterer, and is neither spatially coupled to the antenna conductor 14 supplied with electrical power nor excited.

Furthermore, miniaturization can be achieved by bending toward the metal sash 15 side the distal end part of the antenna conductor 14 that is the monopole conductor included in the antenna device 10.

As described above, the antenna device 10 according to Embodiment 1 includes the transparent antenna conductor 11 that includes the notch 12, the glass 13 that is provided with the antenna conductor 11, the metal sash 15 that is provided adjacent to the antenna conductor 11, and the opaque antenna conductor 14 that is provided to the metal sash 15 without contacting the antenna conductor 11, and is disposed adjacent to the notch 12 without protruding from the metal sash 15 toward the glass 13.

With the magnetic field generated in the antenna conductor 14 by power feeding entering the notch 12, it is possible to excite the antenna conductor 11, without bringing the antenna conductor 11 and the antenna conductor 14 close to each other to the extent that the antenna conductor 14 is exposed through the glass 13. Consequently, the antenna device 10 can excite the antenna conductor 11 without exposing the opaque antenna conductor 14 through the glass 13 provided with the transparent antenna conductor 11, so that the directional gain in the −Z direction (θ=180°) in which the antenna conductor 14 is hidden by the metal sash 15 is improved.

In the antenna device 10 according to Embodiment 1, the antenna conductor 11 has the rectangular shape, and the notch 12 has the linear shape. Consequently, it is possible to implement a parasitic conductor that includes the notch that the magnetic field generated in the antenna conductor 14 by power feeding can enter.

In the antenna device 10 according to Embodiment 1, the antenna conductor 14 is the monopole conductor for which the metal sash 15 is used as the ground potential. Consequently, it is possible to implement a power feeding conductor that enables a magnetic field generated by power feeding to enter the notch 12.

In the antenna device 10 according to Embodiment 1, the antenna conductor 14 is a substrate pattern. Consequently, it is possible to implement a power feeding conductor using the substrate pattern.

### Embodiment 2

FIG. 8 is a perspective view illustrating a schematic configuration of an antenna device 10A according to Embodiment 2. In FIG. 8, the antenna device 10A is an antenna device whose wavelength of the center frequency f₀ of a frequency band for intended use is λ, and includes the antenna conductor 11, the notch 12, the glass 13, an antenna conductor 14A, the metal sash 15, and a power feeding point 16A. In the antenna device 10A, the antenna conductor 11, the notch 12, the glass 13, and the metal sash 15 are also the same as those of the antenna device 10. Each of the dimensions L1, L3A, H1, and D is also the same as those of the antenna device 10.

The antenna conductor 14A is a dipole conductor provided to the metal sash 15. For example, the antenna conductor 14A is an antenna of a belt shape, and the power feeding point 16A is disposed at a center position of the belt shape. Furthermore, as illustrated in FIG. 8, the antenna conductor 14A is an opaque power feeding conductor that is provided to the metal sash 15 without contacting the antenna conductor 11, and is disposed adjacent to the notch 12 without protruding from the metal sash 15 toward the glass 13.

In the metal sash 15, the antenna conductor 14A of the belt shape that is the length L3A is disposed along the X axis direction as illustrated in FIG. 8. The length L3A of the antenna conductor 14A is, for example, 0.5λ. The antenna conductor 14A is disposed adjacent to the open end of the notch 12, and a virtual line along a direction in which the notch 12 linearly extends is perpendicular to a virtual line along a longitudinal direction (+X direction) of the antenna conductor 14A.

For example, the antenna conductor 14A is formed using a metal material such as a sheet metal.

Furthermore, the antenna conductor 14A may be a dipole conductor of a meandering shape. For example, the antenna conductor 14A may employ a configuration including conductors of meandering shapes on both sides of the power feeding point 16A.

The antenna conductor 14A may be a substrate pattern. For example, the antenna conductor 14A is a substrate pattern formed as a copper foil pattern on a dielectric substrate, and the dielectric substrate is provided on the metal sash 15. In a case where the dielectric substrate is a multilayer substrate, the substrate pattern for forming the antenna conductor 14A may be provided not only on a surface layer, but also on an inner layer of the substrate. Note that the substrate pattern also includes vias that electrically connect copper foil patterns between substrate layers.

FIG. 9 is a view illustrating radiation characteristics of the antenna device obtained by removing the antenna conductor 11 from the antenna device 10A, and illustrates a result obtained by simulating the radiation characteristics of the antenna device from which the antenna conductor 11 has been removed. The radiation characteristics are a radio wave radiation pattern of the antenna device on the ZY plane in FIG. 8. Since the antenna conductor 14A is a dipole conductor that does not protrude from the metal sash 15 toward the glass 13 side and extends in parallel to the boundary between the glass 13 and the metal sash 15, that is, in the X axis direction, a main polarized wave is a linearly-polarized wave Eφ indicated by a solid line in FIG. 9 along the X axis direction.

As is clear from FIG. 9, in the antenna device from which the antenna conductor 11 has been removed, a directional gain in the −Z direction (θ=180°) in which the antenna conductor 14A is hidden by the metal sash 15 is lower than that in the +Z direction (θ=0°) and is approximately −5 dBi.

FIG. 10 is a view illustrating radiation characteristics of the antenna device 10A, and illustrates a result obtained by simulating the radiation characteristics of the antenna device 10A. The radiation characteristics are a radio wave radiation pattern of the antenna device 10A on the ZY plane in FIG. 8. Eφ indicated by a solid line in FIG. 10 is a linearly-polarized wave along the X axis direction.

Since, in the antenna device 10A, the antenna conductor 14A is provided to the metal sash 15 without protruding toward the glass 13, and the antenna conductor 14A of the belt shape extends in the X axis direction, the linearly-polarized wave Eφ along the X axis direction is a main polarized wave. As is clear from FIG. 10, the directional gain in the −Z direction of the antenna device 10A is improved by approximately 7 dB compared to the directional gain in the −Z direction of the antenna device illustrated in FIG. 9.

It is considered that the directional gain in the −Z direction illustrated in FIG. 10 is improved because, when electrical power is fed to the antenna conductor 14A in the antenna device 10A, the magnetic field surrounding the antenna conductor 14A is generated, this magnetic field enters the notch 12, and thereby the antenna conductor 11 is excited without being influenced by the metal sash 15. In the antenna device 10A, the cross-polarized wave Eθ is −20 dB or less, and is lower than the cross-polarized wave radiated by the antenna device 10 illustrated in FIG. 3. Hence, illustration of the cross-polarized wave Eθ is omitted in FIG. 10.

As for the antenna conductor 14 that is the monopole conductor included in the antenna device 10, not only an antenna main body, but also the metal sash 15 that is the ground potential radiate radio waves. Hence, the radiation characteristics of the antenna device 10 depend on the shape and the dimensions of the metal sash 15.

By contrast with this, as for the antenna conductor 14A that is the dipole conductor included in the antenna device 10A, a radio wave is not radiated from the shorter plate-like part of the L shape (the part extending in a Z axis direction in FIG. 1) of the antenna conductor 14 of the L shape, and radiation of the radio wave from the metal sash 15 is suppressed. Hence, the cross-polarized wave Eθ is very low.

As described above, the antenna device 10A according to Embodiment 2 includes the transparent antenna conductor 11 that includes the notch 12, the glass 13 that is provided with the antenna conductor 11, the metal sash 15 that is provided adjacent to the antenna conductor 11, and the opaque antenna conductor 14A that is provided to the metal sash 15 without contacting the antenna conductor 11, and is disposed adjacent to the notch 12 without protruding from the metal sash 15 toward the glass 13, and the antenna conductor 14A is the dipole conductor provided to the metal sash 15.

With the magnetic field generated in the antenna conductor 14A by power feeding entering the notch 12, it is possible to excite the antenna conductor 11, without bringing the antenna conductor 11 and the antenna conductor 14A close to each other to the extent that the antenna conductor 14 is exposed through the glass 13.

Consequently, the antenna device 10A can excite the antenna conductor 11 without exposing the opaque antenna conductor 14A through the glass 13 provided with the transparent antenna conductor 11, so that the directional gain in the −Z direction (θ=180°) in which the antenna conductor 14A is hidden by the metal sash 15 is improved.

Furthermore, the antenna device 10A can suppress radiation of a radio wave from the metal sash 15, and the radiation characteristics do not depend on the shape and the dimensions of the metal sash 15.

### Embodiment 3

FIG. 11 is a perspective view illustrating a schematic configuration of an antenna device 10B according to Embodiment 3. In FIG. 11, the antenna device 10B is an antenna device whose wavelength of the center frequency f₀ of a frequency band for intended use is 2, and includes an antenna conductor 11A, a notch 12A, the glass 13, the antenna conductor 14A, the metal sash 15, and the power feeding point 16A. In the antenna device 10B, the glass 13, the antenna conductor 14A, the metal sash 15, and the power feeding point 16A are the same as those of the antenna device 10A. Each of the dimensions L1, L3A, H1, and D is also the same as those of the antenna device 10A.

The antenna conductor 11A is a transparent parasitic conductor. For example, the antenna conductor 11A is a transparent conductive film of a rectangular shape. In FIG. 11, the antenna conductor 11A is a conductor of a square shape whose length of one side is L1. Note that the antenna conductor 11A is not limited to the square shape, and may have an oblong shape or may have a circular shape instead of the rectangular shape. Furthermore, the transparent conductive film is a conductive film formed using a transparent conductive material.

The notch 12A is a notch provided to the antenna conductor 11A, and has a shape whose width widens in a tapered shape as illustrated in FIG. 11. For example, the notch 12A has a shape whose end part on the metal sash 15 side (−Y direction) is opened, and whose width widens toward the direction (+Y direction) apart from the metal sash 15.

In FIG. 11, the notch 12A has a length L2A and has a width W2 at a part that is the farthest from the metal sash 15. The length L2A of the notch 12A is, for example, 0.4λ, and the width W2 is, for example, 0.3λ. The antenna conductor 14A is disposed adjacent to the open end of the notch 12A, and a virtual line along the direction in which the notch 12 linearly extends is perpendicular to a virtual line along the longitudinal direction (+X direction) of the antenna conductor 14A.

FIG. 12 is a view illustrating radiation characteristics of the antenna device 10B, and illustrates a result obtained by simulating the radiation characteristics of the antenna device 10B. The radiation characteristics are a radio wave radiation pattern of the antenna device 10B on the ZY plane in FIG. 11. Eφ indicated by a solid line in FIG. 12 is a linearly-polarized wave along the X axis direction.

Since, in the antenna device 10B, the antenna conductor 14A is provided to the metal sash 15 without protruding toward the glass 13, and the antenna conductor 14A of the belt shape extends in the X axis direction, the linearly-polarized wave Eφ along the X axis direction is a main polarized wave. As is clear from FIG. 12, the directional gain in the −Z direction of the antenna device 10B is improved by approximately 7 dB compared to the directional gain in the −Z direction of the antenna device illustrated in FIG. 9.

It is considered that the directional gain in the −Z direction illustrated in FIG. 12 is improved because, when electrical power is fed to the antenna conductor 14A in the antenna device 10B, the magnetic field surrounding the antenna conductor 14A is generated, this magnetic field enters the notch 12A, and thereby the antenna conductor 11A is excited without being influenced by the metal sash 15. In the antenna device 10B, the cross-polarized wave Eθ is −20 dB or less, and is lower than the cross-polarized wave radiated by the antenna device 10 illustrated in FIG. 3. Hence, illustration of the cross-polarized wave Eθ is omitted in FIG. 12.

FIG. 13 is a graph showing a relationship between radiation efficiency of the antenna device 10A and the antenna device 10B and a normalized frequency. In FIG. 13, the horizontal axis indicates a normalized frequency obtained by normalizing a frequency f of a frequency band for intended use at the center frequency f₀, and the vertical axis indicates radiation efficiency of the antenna device. Furthermore, a relationship indicated by a dashed dotted line represents that of the antenna device 10A, and a relationship indicated by a solid line represents that of the antenna device 10B. As is clear from FIG. 13, the radiation efficiency of the antenna device 10B is improved by approximately 1 dB compared to the antenna device 10A.

When an antenna conductor 14B is excited in the antenna device 10B by power feeding, the antenna conductor 11A resonates in response to this excitation. At this time, the electrical field is generated in the notch 12A, and an induced current also flows in an edge of the notch 12A. The notch 12A has a shape whose width widens in a tapered shape, and the electrical field generated in the notch 12A, and the induced current flowing in the edge of the notch 12A are also reduced. Thus, dielectric loss in the glass 13 caused by the electrical field generated in the notch 12A is reduced, and conductor loss in the antenna conductor 11A caused by the induced current flowing to the edge of the notch 12A is reduced, so that, as illustrated in FIG. 13, radiation efficiency is improved.

As described above, the antenna device 10B according to Embodiment 3 includes the transparent antenna conductor 11A that includes the notch 12A, the glass 13 that is provided with the antenna conductor 11A, the metal sash 15 that is provided adjacent to the antenna conductor 11A, and the opaque antenna conductor 14B that is provided to the metal sash 15 without contacting the antenna conductor 11A, and is disposed adjacent to the notch 12A without protruding from the metal sash 15 toward the glass 13. The antenna conductor 11A has a rectangular shape, and the notch 12A has a shape whose width widens in a tapered shape. The antenna conductor 14B is the dipole conductor provided to the metal sash 15.

With the magnetic field generated in the antenna conductor 14A by power feeding entering the notch 12A, it is possible to excite the antenna conductor 11A, without bringing the antenna conductor 11A and the antenna conductor 14A close to each other to the extent that the antenna conductor 14A is exposed through the glass 13.

Consequently, the antenna device 10B can excite the antenna conductor 11A without exposing the opaque antenna conductor 14A through the glass 13 provided with the transparent antenna conductor 11A, so that the directional gain in the −Z direction (θ =180°) in which the antenna conductor 14A is hidden by the metal sash 15 is improved.

Furthermore, the antenna device 10B can suppress radiation of a radio wave from the metal sash 15, and the radiation characteristics do not depend on the shape and the dimensions of the metal sash 15.

The antenna device 10B includes the notch 12A whose width widens in the tapered shape, so that radiation efficiency is improved.

### Embodiment 4

FIG. 14 is a perspective view illustrating a schematic configuration of an antenna device 10C according to Embodiment 4. FIG. 15 is an arrow view illustrating a schematic configuration of the antenna device 10C seen from a direction of an arrow C in FIG. 14. In FIG. 14, the antenna device 10C is an antenna device whose wavelength of the center frequency f₀ of a frequency band for intended use is λ, and includes the antenna conductor 11A, the notch 12A, the glass 13, the antenna conductor 14B, the metal sash 15, and a power feeding point 16B. In the antenna device 10C, the antenna conductor 11A, the notch 12A, the glass 13, and the metal sash 15 are also the same as those of the antenna device 10B. Furthermore, each of the dimensions L1, L2A, W2, H1, and D is also the same as those of the antenna device 10A.

The antenna conductor 14B is a dipole conductor that is provided to the metal sash 15, includes a metal pad 14B-1 and a metal pad 14B-2 at both ends, and is formed using a metal material such as a sheet metal. More specifically, the antenna conductor 14B includes a belt-shaped part at which the power feeding point 16B is disposed at a center position, and the metal pad 14B-1 and the metal pad 14B-2 that are provided at end parts bent from the both ends of this belt-shaped part toward the metal sash 15 side.

Furthermore, as illustrated in FIG. 14, the antenna conductor 14B is an opaque power feeding conductor that is provided to the metal sash 15 without contacting the antenna conductor 11A, and is disposed adjacent to the notch 12A without protruding from the metal sash 15 toward the glass 13.

The antenna conductor 14B that is a length L3B of the above belt-shaped part is disposed on the metal sash 15 along the X axis direction as illustrated in FIG. 12.

As illustrated in FIG. 15, in the antenna conductor 14B, the metal pad 14B-1 and the metal pad 14B-2 are provided at positions that are separated from the surface of the metal sash 15 by the distance D1. Although, for example, an air layer may be provided between the metal pad 14B-1 and the metal pad 14B-2, and the metal sash 15, a dielectric substrate may be disposed therebetween.

The antenna conductor 14B includes the metal pad 14B-1 and the metal pad 14B-2, and these metal pads are provided at positions that are separated from the surface of the metal sash 15 by the distance D1. As described above, by bringing close to a metal body such as the metal sash 15 these metal pad 14B-1 and metal pad 14B-2 that are the both end parts at which a strong electrical field is generated in the dipole conductor, it is possible to increase a capacitance value generated between the metal pads and the metal sash 15.

The above capacitance value makes it possible to obtain the same characteristics as those of the antenna conductor 14A even when the length L3B of the belt-shape part of the antenna conductor 14B is shortened to, for example, approximately 0.25λ.

That is, the antenna conductor 14B can be shortened and miniaturized more than the antenna conductor 14A.

The antenna conductor 14B may be a substrate pattern. For example, the antenna conductor 14B may be formed by electrically connecting using vias a belt-shaped part of a copper foil pattern formed on one of layers of a multilayer dielectric substrate, and the metal pads 14B-1 and 14B-2 of the copper foil pattern formed on a layer different from that of the belt-shaped part.

Note that, although the antenna device 10C including the antenna conductor 11A and the antenna conductor 14B has been described, it is not limited to this. For example, the antenna device 10C may include the antenna conductor 11 and the antenna conductor 14B. By employing such a configuration, it is possible to implement the small antenna conductor 14B in addition to the effect described in Embodiment 1.

As described above, the antenna device 10C according to Embodiment 4 includes the transparent antenna conductor 11A that includes the notch 12A, the glass 13 that is provided with the antenna conductor 11A, the metal sash 15 that is provided adjacent to the antenna conductor 11A, and the opaque antenna conductor 14B that is provided to the metal sash 15 without contacting the antenna conductor 11A, and is disposed adjacent to the notch 12A without protruding from the metal sash 15 toward the glass 13, and the antenna conductor 14B includes the metal pads 14B-1 and 14B-2 at the both ends.

With the magnetic field generated in the antenna conductor 14B by power feeding entering the notch 12A, it is possible to excite the antenna conductor 11A, without bringing the antenna conductor 11A and the antenna conductor 14B close to each other to the extent that the antenna conductor 14B is exposed through the glass 13.

Consequently, the antenna device 10C can excite the antenna conductor 11A without exposing the opaque antenna conductor 14B through the glass 13 provided with the transparent antenna conductor 11A, so that the directional gain in the −Z direction (θ =180°) in which the antenna conductor 14B is hidden by the metal sash 15 is improved.

Furthermore, the antenna device 10C can suppress radiation of a radio wave from the metal sash 15, and the radiation characteristics do not depend on the shape and the dimensions of the metal sash 15. Furthermore, the antenna device 10C includes the notch 12A whose width widens in the tapered shape, so that radiation efficiency is improved.

Furthermore, in the antenna device 10C, the antenna conductor 14B includes the metal pads 14B-1 and 14B-2 at the both ends, so that it is possible to implement the small antenna conductor 14B.

### Embodiment 5

FIG. 16 is a perspective view illustrating a schematic configuration of an antenna device 10D according to Embodiment 5. In FIG. 16, the antenna device 10D is an antenna device whose wavelength of the center frequency f₀ of a frequency band for intended use is λ, and includes the antenna conductor 11A, the notch 12A, the glass 13, the antenna conductor 14C, the metal sash 15, a power feeding point 16C, and a power feeding cable 17.

In the antenna device 10D, the antenna conductor 11A, the notch 12A, the glass 13, and the metal sash 15 are also the same as those of the antenna device 10B.

The antenna conductor 14C is a folded dipole conductor that is provided to the metal sash 15, and is formed using a metal material such as a sheet metal. In FIG. 16, the antenna conductor 14C is a thin ring-shaped conductor, and part of the ring-shaped conductor is provided with the power feeding point 16C. The power feeding point 16C is connected with the power feeding cable 17. The power feeding cable 17 is a coaxial cable including an outer conductor.

Furthermore, as illustrated in FIG. 16, the antenna conductor 14C is an opaque power feeding conductor that is provided to the metal sash 15 without contacting the antenna conductor 11A, and is disposed adjacent to the notch 12A without protruding from the metal sash 15 toward the glass 13.

The antenna conductor 14B that is a length L3C is disposed on the metal sash 15 along the X axis direction as illustrated in FIG. 16.

The antenna conductor 14C may be a substrate pattern. For example, the antenna conductor 14C is a substrate pattern formed as a copper foil pattern on a dielectric substrate, and the dielectric substrate is provided on the metal sash 15. In a case where the dielectric substrate is a multilayer substrate, the substrate pattern for forming the antenna conductor 14C may be provided not only on a surface layer, but also on an inner layer of the substrate. Note that the substrate pattern also includes vias that electrically connect copper foil patterns between substrate layers.

In a case where a power feeding conductor is a dipole conductor (dipole antenna), it is possible to suppress radiation of a radio wave from a metal member such as the metal sash 15 provided with the power feeding conductor.

However, connecting an unbalanced coaxial cable to a dipole antenna having a length of a half wavelength leaks a current to an outer conductor of the cable, and affects antenna characteristics.

Hence, a conventional antenna device including a dipole antenna to which electrical power is fed through a coaxial cable is provided with a balun to prevent the above current from flowing thereto.

By contrast with this, the antenna device 10D includes the antenna conductor 14C that is not the dipole conductor, but the folded dipole conductor, so that it is possible to prevent leakage of the current to the power feeding cable 17 without providing a balun.

Hereinafter, a result obtained by studying characteristics of an antenna device by replacing the power feeding cable 17 with a metal bar of approximately 0.25% to assume a state where an influence of the power feeding cable in which a current has flown to an outer conductor maximizes will be described.

FIG. 17 is a view illustrating impedance characteristics of the antenna device 10D, and illustrates a result obtained by simulating the impedance characteristics in a case where the power feeding cable 17 is provided and in a case where the power feeding cable 17 is not provided. In FIG. 17, the impedance characteristics indicated by a solid line are impedance characteristics of the antenna device 10D including the power feeding cable 17, and the impedance characteristics indicated by a broken line are impedance characteristics of the antenna device 10D without the power feeding cable 17.

As is clear from FIG. 17, the antenna device 10D has a Voltage Standing Wave Ratio (VSWR)=2 or less at the center frequency f₀ of the frequency band for intended use irrespectively of whether or not the power feeding cable 17 is provided, and keeps a matched impedance. This is because the folded dipole conductor that is the antenna conductor 14C has an input impedance that is four times as high as that of a dipole conductor having the same length, this folded dipole conductor is provided close to the metal sash 15, and therefore radiation resistance is compensated. Thus, the antenna device 10D does not need a matching circuit that matches impedances.

FIG. 18 is a view illustrating radiation characteristics of the antenna device 10D, and illustrates a result obtained by simulating the radiation characteristics of the antenna device 10D in a case where the power feeding cable 17 is provided and in a case where the power feeding cable 17 is not provided. The radiation characteristics are a radio wave radiation pattern of the antenna device 10D on the ZY plane in FIG. 16. In FIG. 18, a radiation pattern indicated by a solid line is the linearly-polarized wave Eφ that is radiated from the antenna device 10D including the power feeding cable 17, and goes along the X axis direction. Furthermore, a radiation pattern indicated by a broken line is the linearly-polarized wave Eφ that is radiated from the antenna device 10D without the power feeding cable 17, and goes along the X axis direction.

In the antenna device 10D, the cross-polarized wave Eθ is −20 dB or less, and is lower than the cross-polarized wave radiated by the antenna device 10 illustrated in FIG. 3. Hence, illustration of the cross-polarized wave Eθ is omitted in FIG. 18.

As is clear from FIGS. 17 and 18, in a case of the antenna device 10D, the impedance characteristics and the radiation pattern change little at the center frequency f₀ irrespectively of whether or not the power feeding cable 17 is provided. This means that, when, for example, the folded dipole conductor that is the antenna conductor 14C has the length of the half wavelength, no current leaks to the outer conductor of the power feeding cable 17. Hence, the antenna device 10D does not need a balun.

Note that, although the antenna device 10D including the antenna conductor 11A and the antenna conductor 14C has been described, it is not limited to this. For example, the antenna device 10D may include the antenna conductor 11 and the antenna conductor 14C. By employing such a configuration, it is possible to provide an antenna device that employs a simple configuration that does not require a balun and an impedance matching circuit in addition to the effect described in Embodiment 1.

As described above, the antenna device 10D according to Embodiment 5 includes the transparent antenna conductor 11A that includes the notch 12A, the glass 13 that is provided with the antenna conductor 11A, the metal sash 15 that is provided adjacent to the antenna conductor 11A, and the opaque antenna conductor 14C that is provided to the metal sash 15 without contacting the antenna conductor 11A, and is disposed adjacent to the notch 12A without protruding from the metal sash 15 toward the glass 13, and the antenna conductor 14C is the folded dipole conductor provided to the metal sash 15.

With the magnetic field generated in the antenna conductor 14C by power feeding entering the notch 12A, it is possible to excite the antenna conductor 11, without bringing the antenna conductor 11A and the antenna conductor 14C close to each other to the extent that the antenna conductor 14C is exposed through the glass 13.

Consequently, the antenna device 10D can excite the antenna conductor 11A without exposing the opaque antenna conductor 14A through the glass 13 provided with the transparent antenna conductor 11A, so that the directional gain in the −Z direction (θ =180°) in which the antenna conductor 14C is hidden by the metal sash 15 is improved.

Furthermore, the antenna device 10D can suppress radiation of a radio wave from the metal sash 15, and the radiation characteristics do not depend on the shape and the dimensions of the metal sash 15.

The antenna device 10D includes the antenna conductor 14C that operates as the folded dipole antenna, and therefore is an antenna device that employs a simple configuration that does not require a balun and a matching circuit.

Note that the embodiments can be combined, random components in the embodiments can be modified, or random components in the embodiments can be omitted.

### INDUSTRIAL APPLICABILITY

An antenna device according to the present disclosure can be used for an in-vehicle wireless communication apparatus, for example.

### REFERENCE SIGNS LIST

10, 10A, 10B, 10C, 10D, 10-1: Antenna device, 11, 11A, 11-1: Antenna conductor, 12, 12A: Notch, 13: glass, 14, 14A, 14B, 14C: Antenna conductor, 14B-1, 14B-2: Metal pad, 15: Metal sash, 16, 16A, 16B, 16C: Power feeding point, 17: Power feeding cable, 100: Antenna device, 101: Antenna conductor, 102: Glass, 103: Antenna conductor, 104: Metal sash, 105: Power feeding point

What is claimed is:

1. An antenna device comprising:
a transparent parasitic conductor including a notch;
a transparent member provided with the parasitic conductor;
a metal member provided adjacent to the parasitic conductor; and
an opaque power feeding conductor provided to the metal member without contacting the parasitic conductor, and disposed adjacent to the notch without protruding from the metal member toward the transparent member.

2. The antenna device according to claim 1, wherein
the parasitic conductor has a square shape, and
the notch has a linear shape.

3. The antenna device according to claim 1, wherein
the parasitic conductor has a square shape, and
the notch has a shape whose width widens in a tapered shape.

4. The antenna device according to claim 1, wherein the power feeding conductor is a monopole conductor for which the metal member is used as a ground potential.

5. The antenna device according to claim 1, wherein the power feeding conductor is a dipole conductor provided to the metal member.

6. The antenna device according to claim 5, wherein the dipole conductor includes metal pads at both ends.

7. The antenna device according to claim 1, wherein the power feeding conductor is a folded dipole conductor provided to the metal member.

8. The antenna device according to claim 1, wherein the power feeding conductor is a substrate pattern.
